(19) United States
(12) Patent Application Publication
(10) Pub. No.: US 2011/0266132 A1
(43) Pub. Date: Nov. 3, 2011

(54) AIR FLOW-CIRCULATION SEAWATER DESALINATION APPARATUS

(76) Inventor: Motohide Takezaki, Konan-Shi Kochi (JP)

(21) Appl. No.: 13/142,669

(22) PCT Filed: Dec. 29, 2008
(86) PCT No.: PCT/JP2008/073876

§ 371 Date: Jun. 29, 2011

(51) Int. Cl. C02F 1/04; B01D 5/00; B01D 1/16

(52) U.S. Cl. 202/233

(57) ABSTRACT

Air flow-circulation seawater desalination apparatus includes a condensation region pipe having upper and lower ends opening in a main body and constituting a boundary wall between an evaporation region outside the pipe and condensation region inside the pipe, a heat supply section for storing heat and keeping an upper part in the main body at a high temperature, an airflow circulator by the lower part of the main body to circulate airflow from the condensation region to the evaporation region, a seawater preheat pipe for preheating raw seawater carried from the outside to the upper part of the evaporation region after penetrating the lower part of the apparatus and passing through the condensation region pipe, and a seawater spray device for spraying the seawater from a high position in the evaporation region and evaporating the seawater to produce high-temperature steam at a high position in the apparatus.

### TECHNICAL FIELD

The present invention relates to an air flow circulation seawater desalination apparatus.

### BACKGROUND ART

There are disclosures of conventional desalination apparatus of seawater which employ the system adopting a seawater evaporation method, such as a multistage flash method, or a seawater desalination method by a reverse osmosis membrane excellent in energy saving (for example, see the following Patent Document 1).
Patent Document 1: Japanese Patent Laid-Open No. 2004-025108

### SUMMARY OF THE INVENTION

### Problems to be Solved by the Invention

However, the above described multistage flash method is complicated in mechanism and consumes a large amount of energy. On the other hand, the seawater desalination by a reverse osmosis membrane is still accompanied by a considerable amount of energy consumption in the seawater desalination process inside the apparatus, and further requires time and efforts for chemical treatment and maintenance, and sometimes causes disposal problem of the resultant condensed seawater and noise pollution. Energy saving, prevention of public pollution, and at the same time enabling making use of various rare resources including salt dissolved in seawater meet the needs of the times.

Is it hence an object of the present invention to provide a seawater desalination apparatus which performs seawater desalination with significantly saved necessary energy by easy handling and a simple mechanism, and also relieves the foregoing public pollution by increasing concentration of substances dissolved in seawater and enabling making use of salt in the seawater as a by-product resource of desalination.

### Means for Solving the Problems

In order to solve the above described problems, the present invention provides the following means (1) to (3)

(1) Specifically, an air flow circulation seawater desalination apparatus of the present invention includes:
a condensing region pipe 15 having a pipe body spirally and vertically extending inside an apparatus main body, and opened into the apparatus main body B at an upper end and a lower end, respectively, and constituting a boundary wall between two regions called “a vaporizing region 1” outside the pipe, and “a condensing region 2” inside the pipe with communication with the vaporizing region 1 at the upper and lower ends;
a heat supply section 13 which is provided in an upper place of the vaporizing region and stores heat to keep an upper side in the apparatus main body at a high temperature;
air flow circulating means F which is provided in a lower side of the apparatus main body and circulates air flow from the condensing region 2 to the vaporizing region 1;
a seawater preheating pipe 3 which penetrates through a lower side of the apparatus from an outside of the apparatus, passes inside the condensing region pipe, and exchange heat exchange while carrying raw seawater 4 from the its upper end to an upper portion of the vaporizing region 1 to preheat the raw seawater 4;
a seawater spraying device S for producing high-temperature steam in the upper place inside the apparatus by spraying the raw seawater from an upper place of the vaporizing region 1 to evaporate the raw seawater;
in the desalination apparatus of seawater, air flow is circulated in both regions of the vaporizing region 1 and the condensing region 2 which are adjacent via the condensing region pipe as a heat exchanger to perform vaporization and steam condensation;
wherein latent heat released when the high-temperature steam with a large buoyant force produced in the upper place of the vaporizing region is sucked from the upper end of the condensing region pipe and returned to water at a lower temperature in a lower side in the condensing region pipe, effectively evaporates seawater in the adjacent vaporizing region, and thereby, steam condensation and seawater evaporation are simultaneously proceed inextricably associated with each other.

(2) the seawater preheating pipe 3 passes in the condensing region 2 in the apparatus, by heat exchange between an inside and an outside of the seawater preheating pipe 3,
and preferably provides a heat recovery step of causing the raw seawater 4 to recover heat of condensed water 9 in the condensing region 2 which is extracted outside the apparatus,
a condensation promoting step of causing the raw seawater 4 to promote steam condensation of air flow in the lower portion of the condensing region 2, and
a temperature raising step of raising temperature of the raw seawater 4 by condensing action of steam which is air flow in the condensing region 2.

By having these steps, the steam pressure of the high-temperature seawater sprayed increases, and even under the condition in which heat energy amount supplied to the apparatus by the heat supply section is small, seawater desalination can be performed efficiently by generating a large amount of steam at a high temperature with high purity in the upper place in the apparatus.

(3) In the seawater desalination apparatus with the aforesaid air flow circulation,

wherein a lower side in the apparatus has a temperature which is different from that of the upper side of the apparatus by storing heat in the upper place in the apparatus and increasing temperature of the upper place in the apparatus with high-temperature steam by the heat supply section 13,

latent heat generated when high-temperature steam obtained by generating by spraying the raw seawater to the upper place of the vaporizing region is sucked to the lower side of the condensing region pipe with a low temperature by the air flow circulating means and returned to water, is directly used for vaporization of seawater of the adjacent vaporizing region, and

continuous heat exchange is preferably kept by causing air flow to circulate in both the regions of the condensing region and the vaporizing region in which vaporization and condensation of steam are simultaneously advanced inextricably associated with each other.

As any of the above described desalination apparatus of seawater, the structure in which the vaporizing region 1 and the condensing region 2 are in contact with each other via the pipe body can be adopted (embodiment 1 which will be described later). The pipe body includes a heat exchanger, and extend spirally from the upper portion to the lower part in the apparatus, for example.

### Advantages of the Invention

In the present invention, the above described means, with easy handling and the simple mechanism, allows seawater desalination by saving energy on a large scale which cannot be possible by the conventional seawater desalination apparatus. Further, the way to acquire salt and others dissolved in seawater, which could be business resources, can be opened, and occurrence of public pollution at the time of seawater desalination can be suppressed.

### BEST MODE FOR CARRYING OUT THE INVENTION

Embodiments of the present invention will be described in detail with reference to the drawings. FIG. 1 is a view showing a basic constitution of an air flow circulation seawater desalination apparatus. FIG. 2 is a view showing a desalination apparatus of embodiment 1 of the present invention, FIGS. 3 to 5 are views showing a desalination apparatus of embodiment 2, FIG. 6 is a view showing a desalination apparatus of embodiment 3, and FIG. 4 is a view showing a desalination apparatus of embodiment 4. FIG. 7 is a graph of saturated steam pressure of water, in which the upper side of the graph at a predetermined temperature shows an air (Air) amount and the lower side thereof shows a steam (Wv) amount.

### (Mechanism and Effect of Air Flow Circulation Seawater Desalination Method)

The principle of the present invention which completely eliminates tremendous energy loss which cannot be avoided in the conventional seawater desalination technique is considered to be explainable with only FIG. 1. This mechanism of separating water from seawater to a high degree and also enabling to obtain salt is very simple, but can easily realize low-cost seawater desalination which conventionally has not existed. FIG. 2 shows “greenhouse type seawater desalination apparatus by air flow circulation” by a casing of a vinyl house, which is a seawater desalination apparatus by air flow circulation of embodiment 1 of the present invention. Embodiment 1 makes most of abundant sunlight to contribute to remedy of global water shortage and realization of a low-carbon society.

### (Mechanism of Low-Cost Seawater Desalination)

FIG. 1 is an explanatory view of the mechanism of seawater desalination by air flow circulation. High-temperature steam with a large buoyant force is accumulated at a high place in a vaporization region by using a heat source at a high place in the apparatus, and the latent heat which generates when the high-temperature steam is returned to water by being forcedly circulated to a lower side of the steam condensation region at a low temperature flows into an adjacent seawater evaporation region to produce the original amount of high-temperature steam efficiently. This mechanism completely overcomes the neck of the heat flow in the phase change portion from gas to liquid and from liquid to gas, which causes waste of a large amount of heat energy in the conventional seawater evaporation desalination method. Making the most of this, low-cost desalination is realized by the method of air flow circulation of a large amount of high-temperature steam which is accumulated while supplying heat energy which can be said to be of a very small amount. As the mechanism, as long as the steam continues to condense, seawater evaporation can be continued to any extent, and therefore, salt also can be obtained as a by-product. The steam which cannot completely condense even after the air flow reaches the lower side of the condensation region returns to the seawater evaporation region.

### (Detailed Description of Seawater Desalination Method by Air Flow Circulation)

The air flow circulation seawater desalination method of the present invention minimizes the heat supply amount by a heat source in order to realize low-energy desalination, even so, it is important for the air flow circulation seawater desalination that the communication portion in the upper place in the apparatus where the air flow circulates at a proper speed is in a high-temperature and high steam pressure state, and a large temperature difference occurs between the high place in the apparatus and the lower side of the circulating air flow. This is easily achieved. Specifically, the specific gravity of steam is only a half of the air component, and in addition, the value of the saturated steam pressure abruptly becomes large as the temperature of water rises (FIG. 7). The higher temperature rises, the more high-temperature steam easily is generated, thus generated high-temperature steam has a very large buoyant force and volume, and therefore, in the seawater evaporation region, rise of the heavy air component is hindered. By expecting this, heat which is required for seawater evaporation is sufficiently supplied from the stream condensation region to the place to which the seawater which increases in temperature by a seawater preheating pipe is sprayed from the upper place of the seawater evaporation region, which is also the mechanism for returning the steam in a steam condensation region pipe to water, and does not require cooling water at all for returning steam to water though the seawater evaporation desalination method is adopted.

The important things for the mechanism of the apparatus to function favorably are making only the variation amount of the temperature of the air flow circulating vertically inside the apparatus as large as possible while keeping the temperature difference between the inlet port of the seawater at the bottom of the apparatus and the outlet port of the fresh water small, whereby the steam pressure in the air flow repeats variation slowly and rhythmically on a large scale, and that is the progress of desalination of seawater without causing energy exhaustion.

In this apparatus, the temperature at which the steam returns to water in the steam condensation region pipe is not low, and therefore, high-temperature water is not dropped abruptly, but the concept of connecting its sensible heat to seawater evaporation is required. Since the air flow temperature of the fresh water accumulating on the bottom of the apparatus and its surface portion is higher than the concentrated seawater pool above them on the upper side, the seawater preheating pipe is functioned to capture the heat for seawater evaporation. Further, in extracting the concentrated seawater, salt and fresh water, which are the results of seawater desalination, heat exchange is performed with seawater which enters the apparatus, and this has the role like a dam which stems the flow-out of the heat flow. By the series of devices, the energy amount at the upper place inside the apparatus increases, and the desalination efficiency is enhanced. Assuming that the heat amount which flows outside the apparatus through fresh water, salt and the like is equal to the heat supply amount by heat source, the temperature difference between the original seawater and fresh water is at will, and the energy balance calculation of desalination is easy.

Various desalination scales are considered, from small one with daily output of several tons to several hundred thousand tons. In the air flow circulation seawater desalination method, as the heat exchange capacity of the steam condensation region pipe which is a heat exchanger becomes larger, the amount of fresh water which is generated in its portion becomes large. This acts to reinforce the upper place in the apparatus to the high energy state, and therefore, the heat energy amount to be supplied does not need to be increased proportionally to the desalination scale. Thus, reduction in the temperature difference between the inlet port of the seawater and the outlet port of the fresh water is a natural course, and it is estimated that the heat energy supply amount to make about 1° C. difference has less possibility of significantly reducing the high energy state of the upper place inside the apparatus. With the reason which will be described as follows, it is considered that in the air flow circulation desalination method, 500 tons of fresh water is easily obtained with the energy amount equivalent to one ton of steam.

### (Counter-Air Flow High-Temperature Heating Method is Preferable for Energy Input)

In the air flow circulation seawater desalination method aiming at reduction in energy, it is desired to make the air flow temperature in a communication portion of the upper place inside the apparatus high with very small heat energy supply, and energy supply with heat energy immediately absorbed in evaporation latent heat is considered to be waste of energy. Then, what course of action should be taken? First, cold seawater which is a desalination raw material is pulled at a pressure into the seawater preheating pipe from the bottom of the apparatus, and by only exchanging heat with the steam condensing region and the like via the preheating pipe, the temperature is increased as much as possible.

Subsequently, the seawater is directly sprayed from the upper place of the vaporizing region, whereby evaporation occurs, and heat of vaporization is taken from the surroundings to somewhat decrease the temperature. This is a necessary and favorable phenomenon for causing the steam in the condensing region to condense. The heat energy supply to follow is direct heating to the air flow (main component is steam) in the communication portion in the upper place in which there is nothing to vaporize, and the same concept may be considered to be applied to the case of the greenhouse type seawater desalination of embodiment 1 which will be described later. According to this method, heat of the heat source is not absorbed by the latent heat of seawater evaporation, and therefore, increase in temperature of the air flow in the upper place inside the apparatus to over 100° C. requires much lower energy than boiling seawater. When the high-temperature steam thus obtained enters the steam condensing region pipe, and intensely heats the seawater evaporation surface outside thereof with a large area, the energy state of the air flow toward the communication portion of the upper place in the seawater evaporation region becomes high-temperature close to 100° C., and the steam pressure is also significantly close to the value of atmospheric pressure (FIG. 7).

The structure of the present apparatus in which the high-temperature steam with a huge buoyant force circulates to the low-temperature lower side from the upper place inside the apparatus and seawater desalination advances hardly wastes heat energy if only heat insulation to the outside of the apparatus is completely provided. The fresh water which is generated at a high temperature inside the steam condensing region pipe gently flows in the horizontal direction to have a lower temperature gradually, and finally at a low temperature flows out the apparatus from the bottom thereof. The heat energy supply method is not necessarily limited to the air flow heating, but the counter air flow high temperature heating method as the heat energy supply means for air flow circulation seawater desalination is considered to be able to further dramatically enhance the effect of the air flow circulation seawater desalination method which is originally a low-energy seawater desalination method.

### (Construction of FIG. 1)

In FIG. 1, the inside of a vertical volumetric type apparatus main body is partitioned in the vertical direction with an inner wall B2 having a heat exchanger, and is partitioned in the lateral direction with an inner bottom B3 which extends from the inner wall B2 to an outer wall at one side. The area partitioned by the inner wall B2, the inner bottom B3 and a part of the outer wall of the apparatus main body is a vaporizing region 1, and the other region is a condensing region 2. A discharge pipe for condensed seawater penetrates through the inner bottom B3 at the central lowermost and communicates with the vaporizing region, and the condensed seawater staying on the inner bottom B3 of the lower portion of the vaporizing region is discharged outside the apparatus main body. Further, a lower communication pipe 80 with a fan F disposed inside penetrates through the inner bottom B3, the lower communication pipe 80 opens to the front side and back side of the inner bottom B3 to communicate with the vaporizing region 1 and the condensing region 2, respectively. The upper end of the lower communication pipe 80 is disposed inside the storage place of the concentrated seawater at the lower portion of the vaporizing region 1, and the fan F in the lower communication pipe 80 exhausts air from the back side (lower side) of the inner bottom B3 toward the front side (upper side), whereby the air flow is ejected into concentrated seawater 6. The air flow which is fed into the vaporizing region 1 by ejection of the air flow into the concentrated seawater 6 ascends inside the vaporizing region 1, thereafter, goes beyond the upper edge of the inner wall B2 which is lower than the ceiling of the apparatus main body to move into the condensing region 2 beyond the inner wall B2, descends inside the condensing region 2, and is sucked into the opening at the lower end of the lower communication pipe 80 again. In this manner, the air flow repeatedly circulates between the vaporizing region and condensing region. The bottom portion of the apparatus main body is recessed to be in a bowl shape, so that the condensed water which is generated by condensing in the condensing region 2 is stored. A discharge pipe for condensed water 9 penetrates through the bottom portion of the apparatus main body at the central lowermost position of the bottom portion of the apparatus main body and communicated with outside, and the condensed water 9 is recovered to the outside of the apparatus main body. The lower end of the lower communication pipe 80 is disposed so as to be always above the water level of the condensed water 9 which is stored in the bottom of the apparatus main body, which allows circulation of the air flow irrespective of the storage amount of the condensed water.

Further, a lower seawater preheating pipe 30 which feeds raw material seawater into the apparatus main body penetrates through the bottom portion of the apparatus main body, and the lower seawater preheating pipe 30 meanders in the vicinity of the upper surface of the bottom portion, and communicates with the seawater preheating pipe 3 which extends in the vertical direction inside the apparatus main body. By the meandering portion of the lower seawater preheating pipe 30, the heat energy in the condensed water 9 is recovered, and discharge of heat to the outside of the apparatus is restrained.

### (Heat Source of Heat Supply Section 13)

The desalination method by the apparatus can be said to follow the mechanism of rainfall that is the circulation of water in the natural world, and therefore, seawater desalination by air flow circulation is possible freely in a wide range of the temperature of the upper place inside the apparatus of about 30° C. to 100° C. Accordingly, as long as extremely high efficiency is not required, there are a variety of kinds of heat source for the heat supply section 13. Meanwhile, the method like a green house in FIG. 2 is considered to be easy and capable of effectively using natural energy at low construction cost. (The wave shaped arrows in FIGS. 1 and 2 show heat which transmit into and enter the apparatus main body (heat source of the heat supply section 13).)

### (Technical Problems and Future of Final Seawater Desalination Cost)

“Desalination ratio of 90%” in the section of the energy balance calculation in the present application means that 900 kg of fresh water is obtained from 1 ton of seawater.

When 100% of water is to be obtained from the seawater of concentration of 3.4%, not only a scale but also particles of salt or the like sometimes firmly adhere together like a rock. For the purpose of solving the adhering, by repeating trials and errors such as adoption of air flow injecting and circulating means as embodiment 1 also washing away contamination by largely pulsing the passing seawater amount, or fining down the particles by stirring the concentrated seawater which stores on the bottom, so that the present invention is considered to be realized. For seawater desalination, contamination, scales, corrosion, energy for driving a seawater pump and the like, heat loss, and the like can be coped with to the extent of the level which is already verified in the seawater evaporation desalination methods of predecessors. As compared with the conventional desalination technique, the mechanism of the air flow circulation seawater desalination is unbelievably simply, and the temperature, pressure and the like to be set are at the level of the daily life of a man. Therefore, the construction cost of the desalination plant and also the maintenance cost after the construction are reduced. The air flow circulation seawater desalination method significantly reduces the cost in the reverse osmotic membrane seawater desalination method and the like not only because of low energy but also because of almost all the aspects.

### (Energy Balance)

The energy balance of the seawater desalination method by the air flow circulation of the present invention is generally considered as follows.

[Object] How much fresh water is obtained from the energy amount equivalent to 1 ton of steam is provisionally calculated.

[Concept] Since the total heat amount which flows outside the apparatus through fresh water, salt and the like from the air flow circulation seawater desalination apparatus is in the relation which is said to be equal to the heat supply amount by the heat source, the temperature difference between the original seawater and fresh water is at will, and the simple calculation formula as follows is obtained for energy balance of desalination. For the latent heat and specific heat, rough answers are derived with change in temperature and salt concentration being taken into consideration.

(A) latent heat of 1 ton of steam÷(B) discharge heat energy amount per 1 ton of medium×(C) desalination ratio=(D) fresh water amount that can be produced with 1 ton of steam (ton)

(1) When the latent heat of steam is set as 550 kcal/kg, the specific heat of seawater or the like to be dealt is set as 1 kcal/kg as fresh water, the heat medium B which flows out of the apparatus is fresh water, concentrated seawater and precipitation, which constitute one unit, and when the temperatures of them are same, calculation is considered to be easy with few errors.

(2) The desalination ratio is provisionally calculated as about 90% at which salt deposits since water can be completely separated from seawater in principle, and this means that 900 kg of fresh water is obtained from 1 ton of seawater.

(3) Provisional calculations when the temperature differences of B are set as 2° C., 1° C. and 0.1° C. are tabulated. Value 4950 tons in the case of c is made the realization target for the reason which is already described. For information, in the conventional reverse osmosis membrane method, the value is considered to be only beyond 200 tons

TABLE 1

| | A | B | C | D (ton) |
|---|---|---|---|---|
| A | 550 | 2 | 90% | 247.5 |
| B | 550 | 1 | 90% | 495 |
| C | 550 | 0.1 | 90% | 4950 |

### Embodiment 1

FIG. 2 is a schematic view explaining a vertical sectional structure of an air flow circulation seawater desalination apparatus of embodiment 1 of the present invention. In embodiment 1, a vinyl sheet having translucency is used as a casing B1 which forms a wall and a ceiling part of an apparatus main body B, and by being installed outdoors, the temperature of the inside of the apparatus main body B rises by sunshine. Specifically, the sun outside the apparatus main body B is used as a heat source. Further, in embodiment 1, a lower end of a condensing region pipe 15 is closed, and three pipes that are the lower communication pipe 80, the recovering pipe for the condensed water 9 and a water supply pipe for raw seawater 4 penetrate the lower end and communicate with the condensing region pipe.

Among them, the lower communication pipe 80 has the fan F as air flow circulating means in the pipe, and one end of it communicates with an upper portion of the end surface of the condensing region pipe 15, whereas the other end opens to a lower portion of the apparatus main body B. Air flow is ejected into the concentrated seawater 6 which is stored in the lower portion of the apparatus main body B from the opening at the other end of the lower communication pipe 80, and the air flow is circulated in the entire apparatus main body B (see the dotted line arrow of FIG. 2).

Further, the spiral condensing region pipe 15 with the upper and lower ends being opened is installed in the apparatus main body B, and the inside of the condensing region pipe 15 forms a condensing region 2. A seawater spraying device S which sprays raw material seawater is provided at an upper portion in the region inside the apparatus main body B and outside the condensing region pipe, and the entire region is a vaporizing region 1.

### <Basic Construction of Desalination Apparatus of Embodiment 1 (FIG. 2)>

In the air flow circulation seawater desalination apparatus of the present invention, the vaporizing region 1 which vaporizes the seawater in the region and obtains steam, and a condensing region 2 which condenses the steam inside the region and obtains fresh water are adjacent to each other via the condensing region pipe 15 including of a heat exchanger which forms a boundary wall between these regions, and the respective regions communicate with each other in a lower communication part 8 at the tip of the lower communication pipe 80 which is located at a lower side in the apparatus, and an upper communication part 7 which is located at an upper side in the apparatus. A heat supply section 13 is provided at an upper portion in the apparatus, so that heat is accumulated to fill the upper side in the apparatus with high-temperature steam. The fan F as the air flow circulating means which circulates the air flow between the vaporizing region 1 and the condensing region 2 is included in the lower communication pipe 80.

By using proper air flow circulation, the steam at a high temperature with a large buoyant force naturally goes upward in the apparatus, and heat is accumulated. Meanwhile, the present invention aims at desalination with less energy, and therefore, a very small amount of heat energy is supplied by the heat source. Therefore, the circulating air flow at the lower side of the apparatus near an extraction port such as fresh water which discharges heat is not at a high temperature.

Further, a seawater preheating pipe 3 is provided, which communicates with a raw seawater tank 40 outside the apparatus, penetrates through the lower side of the apparatus, and passes through the condensing region 2 inside the apparatus to feed the raw seawater 4 to the vaporizing means in the vaporizing region 1 in the vicinity of the upper communication part 7 while preheating the raw seawater 4. The seawater preheating pipe 3 is a pipe body which extends from the lower side to the upper side in the condensing region 2, preheats the raw seawater 4, and feeds the raw seawater 4 to the vaporizing means at the upper portion of the vaporizing region 1 while promoting condensation of the steam from the air flow in the lower portion of the condensing region 2.

The raw seawater 4 which is carried to the upper portion in the apparatus while being preheated by the seawater preheating pipe 3 is released into the vaporizing region 1 by the vaporizing means, and the steam is vaporized. In each embodiment, as the vaporizing means, the seawater spraying device S having a number of spray nozzles as shown in FIG. 4 is used. By spraying the preheated seawater (the raw seawater 4 or the concentrated seawater 6) as fine particles from the upper place of the vaporizing region 1 in the vicinity of the heat supply section 13, idealistic vaporization can be promoted.

The steam at a high temperature which is thus vaporized from the raw seawater 4 or the concentrated seawater 6, and is substantially saturated to have little air content is forcedly introduced into the condensing region 2 from the upper communication part 7 by the current circulating means. When the steam enters the condensing region 2, the temperature difference from the vaporizing region 1 occurs and the steam condenses. Thus, the condensed water 9 which is hot water is produced.

At this time, in the vaporizing region 1, the seawater being heated by the condensing region 2 at a high temperature, the steam pressure of the seawater rises, and the air flow temperature in the vaporizing region 1 rises at the same time to promote vaporization of the raw seawater 4. Thus, by continuing the current circulation between the condensing region 2 and the vaporizing region 1, and the heat exchange combining vaporization and condensing action of steam, seawater desalination can be performed.

In the conventional seawater desalination method, when the steam separated from seawater is returned to water, seawater is used as the cooling material, and the condensing heat is cooled by the seawater to be recovered into the seawater. However, it is difficult to recover condensing heat completely, and a large amount of heat loss in the gas-liquid phase change cannot be avoided. Further, in the reverse osmosis membrane method which has been conventionally considered to be superior in the aspect of energy cost, a large amount of concentrated seawater 6 is discarded. In contrast with them, in the seawater desalination method by air flow circulation of the present invention as described above, all of heat of condensation of steam is directly used for vaporization of seawater. Therefore, heat is not wasted, and seawater for cooling is not needed. Therefore, seawater desalination is completed in the apparatus of the present invention, the cause of the heat energy consumption inside the apparatus hardly occurs, and the concentrated seawater 6 hardly needs to be discarded. Therefore, the present invention is also obviously superior from the aspect of energy cost, and the operation cost of desalination can be reduced to be extremely low.

### (Current Circulating Means)

The air flow which circulates inside the apparatus repeats increase and decrease in the steam amount contained in the air flow in accordance with the temperature change in each of the regions through which the air flow passes (see FIG. 7). Here, in the vicinity of the lower communication part 8 in the lower portion of the apparatus, the temperature is the lowest among the respective regions in the apparatus, the steam content in the air flow almost disappears, and the air flow amount becomes the minimum. When the amount of steam becomes small, the specific gravity of the air flow becomes large. Therefore, by providing the fan F in this place, the air flow can be easily controlled without opposing the buoyant force, and circulation of the air flow can be smoothly performed.

When steam is generated from the seawater in the upper place in the vaporizing region 1 for the ascending air flow, the air content with a large specific gravity is prevented from ascending, and high-temperature steam naturally gathers at the upper side in the apparatus. Thus, the upper portion in the apparatus is soon brought into the state saturated with steam at a high temperature. In the upper portion in the apparatus, the air flow at a high temperature with a very small amount of the air content being included in much steam is introduced into the condensing region 2 from the upper communication part 7, and thereafter, is forcedly blown to the vaporizing region 1 from the condensing region 2 by the fan F which is the air flow circulating means provided in the vaporizing region 1 in the vicinity of the lower communication part 8. Thus, the air flow circulates inside the apparatus.

In the present invention, vaporization in the vaporizing region 1 and condensation in the condensing region 2 are allowed to proceed simultaneously in close cooperation by forcedly introducing steam with a large buoyant force into the condensing region 2 in this manner.

In the upper communication part 7, the air flow at a high temperature and high steam pressure has a large buoyant force, and the air flow is to stay in the place without a compelling force of the air flow circulating means. Thus, the fan F, which is the air flow circulating means, is disposed in the lower communication pipe 80, and blows air into the vaporizing region 1, whereby the gas having a large buoyant force is sucked into the condensing region 2 and is allowed to descend inside the condensing region 2. In embodiment 1, the lower communication pipe 80 penetrates through the inner bottom B3 at the lower portion of the vaporizing region 1, the upper end of the lower communication pipe 80 opens into the concentrated seawater which is stored in the lower portion of the vaporizing region, and the lower end opening opens at the lower back side of the inner bottom B3. The fan F blows air from the lower side to the upper side in the lower communication pipe 80, and thereby, ejects the air flow into the concentrated seawater 6 in the lower portion of the vaporizing region 1.

### (Seawater Preheating Pipe 3)

The seawater preheating pipe 3 passes inside the condensing region pipe 15 which is partitioned with the inner wall B2 including a heat exchanger, and supplies the raw seawater 4 into the vaporizing region 1 in the apparatus while preheating the raw seawater 4 by heat exchange inside and outside the pipe. Until reaching the vaporizing means in the vaporizing region 1 in the apparatus, the raw seawater 4 is subjected to a heat recovering step of recovering heat to the raw seawater 4 from the condensed water 9 which is taken outside the apparatus, a heat recovering step of promoting steam condensation of the air flow in the lower portion of the condensing region 2, and a temperature increasing step by the condensing action of the steam which is the air flow in the condensing region 2. By the three steps, the raw seawater 4 is in the high-temperature state by the time when it reaches the vaporizing means.

### (Vaporizing Means)

The vaporizing means is the means which promotes vaporization of the seawater in the vaporizing region 1, and more specifically, vaporization is performed by the seawater spraying device S (embodiments 1 to 4) which sprays the seawater from the upper portion of the region. If the seawater spraying device S is included, even if the salt 5 and scales inside the raw seawater 4 deposit, they can be easily cleaned. The mode of each of embodiments 1 to 4, which preheats and heats the seawater by the seawater preheating pipe 3 and the heat supply section 13 and uses the seawater spraying device S provided at the upper place in the vaporizing region 1, is the most efficient steam generating method.

The raw seawater 4 which is at a high temperature by the seawater preheating pipe 3 not only efficiently vaporizes from the evaporation surface of the heat exchanger which is wet with the seawater but also from suspending mist of the raw seawater 4 by being sprayed from the upper place of the vaporizing region 1 by the seawater spraying device S.

Heat is already stored inside the apparatus by continuous operation of the apparatus, and the upper portion of the vaporizing region 1 is in the state at a high temperature and high steam pressure, in addition to which, steam condensing heat also always flows in from the condensing region 2. Therefore, reduction in temperature by seawater evaporation of the vaporizing region 1 is prevented. As a result that steam is actively generated and the volume thereof increases, the air content with a large specific gravity hardly ascends, and a saturated air flow state at a high temperature can be kept in the vicinity of the upper communication part 7. Thereby, even when the amount of the air flow passing through the fan F which is the lower air flow circulating means is very small, seawater desalination by the air flow circulation is efficiently performed.

### (Heat Supply Section 13)

The heat supply section 13 supplies heat to the area in the vicinity of the upper communication part 7 at the upper portion in the apparatus, and heats the seawater in the apparatus or the air flow in the vaporizing region 1. For more efficient seawater heating, the one that directly heats the air flow immediately after the raw seawater 4 is supplied into the vaporizing region 1 is preferable. Water content immediately after the high-temperature raw seawater 4 is supplied into the vaporizing region 1 and evaporated, that is, the steam in the state with no a liquid content, is provided, and it is desirable to heat the steam to the boiling temperature of the seawater or higher in the vicinity of the upper communication part 7.

By directly heating the air flow of the steam with no liquid content, the air flow temperature in the vicinity of the upper communication part 7 can be made higher than the boiling point of the seawater. With the air flow of the upper communication part 7 at the temperature exceeding the boiling point as the heat source, the temperature of the raw seawater 4 which is sprayed from the seawater spraying device S which is the vaporizing means is raised to the boiling point, and the steam pressure of the air flow in the vicinity of the upper communication part 7 can be maximized. By the high-temperature air flow in the vicinity of the upper communication part 7 which includes only a small amount of air content, highly efficient desalination of seawater can be realized.

The heat which is supplied by the heat supply section 13 is transferred as follows thereafter. First, the heat which is supplied by the heat supply section 13 provided in the vicinity of the upper communication part 7 at the upper side in the apparatus is stored in the heat storing region at the upper portion in the apparatus with the steam as a medium in the upper portion in the apparatus. Therefore, during a seawater desalination operation, the upper portion in the apparatus is kept at a higher temperature than the lower portion in the apparatus, and the heat storing region is formed. Thereafter, the high-temperature steam is forcedly introduced into the condensing region 2 by the air flow circulating means, and releases the heat of condensation in the condensing region 2 at the condensing time, and the heat is transferred to the raw seawater 4 in the seawater preheating pipe 3 and into the vaporizing region 1.

The heat supply section 13 is not always provided in the vicinity of the air flow outlet port of the upper communication part 7. As the heat source which is supplied by the heat supply section 13, a wide variety of heat sources such as waste heat accompanying power generation and marine engine operation, and solar heat can be used, since the heat source with a large heat amount is not always required.

(Seawater Desalination Method by Air flow Circulation)

In the seawater desalination method by air flow circulation of the present invention, the desalination apparatus is operated under natural atmospheric pressure, and almost all the heat energy required for seawater evaporation in the vaporizing region 1 is provided by the heat of steam condensation in the steam condensing region 2. Due to the air flow circulation, the heat exchanger in the boundary of each region performs heat exchange, whereby desalination of seawater is performed. More specifically, by the air flow circulation between the vaporizing region 1 and the condensing region 2, the steam which is evaporated from the seawater in the vaporizing region 1 condenses in the condensing region 2, and the steam which cannot condense enters the vaporizing region 1 again.

The vaporizing and condensing actions simultaneously proceed inextricably associated with each other due to change in the air flow state and occurrence of the temperature difference between the vaporizing region 1 and the condensing region 2. In addition to that the specific gravity of steam is very small as compared with atmosphere, saturated steam pressure becomes abruptly large in the high-temperature range, to which the expansion effect of the temperature is added, and thus, the gas in the upper place in the apparatus has a large buoyant force. Therefore, the high-temperature steam can be reliably confined in the upper portion in the apparatus with a simple mechanism.

The high-temperature steam confined in the upper portion in the apparatus is fed to the lower portion in the apparatus by the fan F in the lower communication pipe 80, and thereafter, the air flow is repeatedly and forcedly circulated in the vertical directions in the apparatus. Seawater desalination is continuously performed by repeating the air flow circulation accompanied by heat exchange in which the air flow moves upward passing through the vaporizing region 1, and when it moves downward passing through the condensing region 2.

Further, the raw seawater 4 is fed under pressure through a pressure-feeding pipe (a seawater preheating pipe 3) which extends inside the apparatus, and is sprayed and dispersed into the vaporizing region 1 at the upper portion in the apparatus. Heat exchange is also performed inside and outside the pressure-feeding pipe (the seawater preheating pipe 3) to serve the purpose of heat energy saving of seawater desalination.

By performing seawater desalination in this manner, heat loss accompanying heat release at the time of change of gas and liquid phase can be suppressed to the minimum, and seawater desalination rate can be increased to the maximum. Although having a simple mechanism, the seawater desalinating apparatus can produce a large amount of fresh water with an extremely small amount of energy, and causes less public pollution. High manufacture cost and time and efforts in maintenance are not required. These are the results which cannot be achieved by the conventional seawater desalination method.

In the air flow circulation type seawater desalination method as described above, seawater desalination is performed at the boiling temperature of the seawater or lower under the atmospheric pressure, and therefore, the structure for seawater spraying becomes simple among others.

Contamination such as the precipitation of the salt 5 in the vaporizing region 1 can be washed away by an injection cleaning device 14 of the clean raw seawater 4. Further, as for treatment of the scale adhering to the periphery of the seawater spraying device S, it can be cleaned by storing the gas being generated during seawater desalination. In accordance with necessity, the chemical solution in which a chemical is dissolved is used in the injection cleaning device 14, and the scale can be washed away with the chemical solution.

The present apparatus is capable of producing fresh water with extremely high seawater desalination ratio by adjusting and decreasing the supply amount of the raw seawater 4 little by little. If the supply amount of the raw seawater 4 is extremely decreased, the concentrated seawater 6 cannot reach the lower portion of the vaporizing region 1, and dried salt 5 deposits on and adheres to the vaporizing region 1. Therefore, by using this, production of salt 5 can be performed with seawater desalination. Higher fresh water production ratio reduces the cost of fresh water production, and public pollution by discarding the concentrated seawater 6 is eliminated. Thus, by changing the seawater desalination ratio in accordance with purposes, resource value of such as a useful trace element in the seawater is ensured.

### Embodiment 2

FIGS. 3 to 5 are views showing an air flow circulation seawater desalination apparatus of embodiment 2 of the present invention. Among them, FIG. 3 is an explanatory view schematically showing a vertical sectional structure, and FIGS. 4 and 5 are sectional views taken along the lines I-I and II-II of FIG. 3, respectively. The desalination apparatus of embodiment 2 has one vaporizing system which heats and evaporates the raw seawater 4 in the vaporizing region 1 only once, and one condensing system which feeds the heated and evaporated gas into the condensing region 2 and condenses the same, successively performs vaporization and condensation in one combined system of these systems while circulating the air flow between both the regions, and also recovers the concentrated seawater 6. More specifically, as shown in FIG. 3, a duct including a heat exchanger spirally extending along the vertical direction in the apparatus main body B is provided as a condensing region pipe 15. The condensing region pipe 15 is opened into the apparatus main body B in the upper communication part 7 at an upper end and in the lower communication part 8 at a lower end respectively.

The condensing region pipe 15 of embodiment 2 is constituted in a way that a circular duct spirally extends vertically, but could be in another way that a plurality of ducts extending in a whirlpool shape in one plane with an outermost part and a center part being as respective ends are disposed vertically spaced from and connectedly each other (not illustrated). In this case, the condensing region 2 is formed in a step shape in the vertical direction in the apparatus main body B.

Further, in the pipe in the vicinity of the lower end of the condensing region pipe 15, the fan F as the air flow circulating means is provided. By means of the air flow circulation means, letting the air flow from the upper end of the condensing region pipe 15 to the lower end thereof through the inside of the pipe, and further, from the lower end into the apparatus main body B outside the pipe causes the air ejected into the apparatus main body B from the lower end of the condensing region pipe 15 to run through the inside of the apparatus main body B to the upper end of the condensing region pipe 15 so as to circulate inside and outside the condensing region pipe 15.

Further, in the vicinity of the upper end of the condensing region pipe 15, the seawater spraying device S is provided as the vaporizing means for vaporizing raw seawater 4. With that, the inside of the condensing region pipe 15 becomes the condensing region 2, and the entire space inside the apparatus main body B but outside the pipe becomes the vaporizing region 1. The open portion at the upper end of the condensing region pipe 15 becomes the upper communication part 7 which allows the vaporizing region 1 and the condensing region 2 to communicate with each other at the upper side in the apparatus main body B, and the open portion at the lower end of the condensing region pipe 15 becomes the lower communication part 8 which allows the vaporizing region 1 and the condensing region 2 to communicate with each other at the lower side in the apparatus main body B.

The heat exchange hose as the seawater preheating pipe 3 extends from the vicinity of the lower communication part 8 to the upper communication part 7 in the condensing region pipe 15, and thereafter, the heat exchange hose is projected from the upper communication part 7 to communicate with the seawater spraying device S at the upper side in the apparatus main body B. Further, the heat exchange hose as the seawater preheating pipe 3 communicates with a water supply pipe at the lower end in the vicinity of the lower communication part 8. The water supply pipe communicates with the raw seawater tank 40 via a pump of the raw seawater 4 and a valve, and penetrates into the inside of a branch pipe 150 to pass through the inside of the branch pipe 150 and communicates with the heat exchange hose as the seawater preheating pipe 3 at the branching portion of the branch pipe 150.

The raw seawater 4 in the raw seawater tank 40 is fed into the apparatus main body B by the pump, further into the inside the seawater preheating pipe 3 running inside the condensing region 2, and, while being preheated, fed under pressure into the seawater spraying device S at the upper side from the lower side in the apparatus, and sprayed from the seawater spraying device 3 into the vaporizing region 1 in the apparatus main body B. The upper portion in the apparatus is heated by the heat supply section 13, and most of the sprayed seawater is released from the upper side to the lower side in the apparatus to vaporize.

By the extremely small specific gravity and the fan F as the air flow circulating means, the vaporized steam goes to the upper side in the apparatus main body B and is guided into the condensing region pipe 15 from the upper communication part 7.

Thereafter, the vaporized air flow condenses in the condensing region pipe 15, and the condensed water 9 flows down in the condensing region pipe 15. The part in the vicinity of the lower communication part 8 of the condensing region pipe 15 extends substantially in the horizontal direction, and a branch pipe 150 extends downward from and communicates with the part extending in the horizontal direction. The branch pipe 150 further communicates with a condensed water tank 90 outside the apparatus main body B via a check-valve 17 and a valve. The check-valve 17 prevents the air flow from flowing into the apparatus main body B through the branch pipe 150. The condensed water 9 which is generated in and flows down in the condensing region pipe 15 is guided into the branch pipe 150 without going to the lower communication part 8, and thereafter, is recovered into the condensed water tank 90.

The raw seawater 4 which is sprayed into the vaporizing region 1 but not vaporized is stored as the concentrated seawater 6 in the reservoir of the concentrated seawater 6 at the bottom portion of the apparatus main body B which is the lower portion inside the vaporizing region 1. The bottom portion of the apparatus main body B communicates with the upper portion of the concentrated seawater tank 60 provided outside the apparatus main body B via the valve, and thereby, the stored concentrated seawater 6 can be recovered.

Further, outside the apparatus main body B, the condensed water tank 90 is provided ahead of the branch pipe 150 which communicates with the inside of the apparatus via the check-valve 17 and the valve, and the raw seawater tank 40 is provided ahead of the water supply pipe penetrating through the branch pipe 150 via the pressure pump P.

### (Air Flow Circulating Means)

The fan F as the air flow circulating means is provided in the condensing region pipe 15 in the vicinity of the lower communication part 8 as shown in FIGS. 3 and 5, and the steam generated in the vaporizing region 1 is properly forcedly introduced into the condensing region 2 to circulate the air flow between the respective regions.

### Embodiment 3

FIG. 6 is a schematic view explaining a vertical sectional structure of an air flow circulation seawater desalination apparatus of embodiment 3 of the present invention. In addition to embodiment 1, embodiment 3 has a lower chamber 20 partitioned with an inner bottom B3 and also has a secondary system which vaporizes the concentrated seawater 6 again (in the same vaporizing region 1). Thus, embodiment 3 can produce and recover salt 5 as a by-product at the same time. Specifically, embodiment 3 (FIG. 6) has one vaporizing region 1, one condensing region 2, and vaporizing means with two systems passing through the inside of the condensing region 2. More specifically, a first vaporizing system which heats and evaporates the raw seawater 4 in the vaporizing region 1, a second vaporizing system which heats and evaporates again the concentrated seawater 6 not fully heated to evaporate and stored in the inner bottom B3 of the vaporizing region 1, and one condensing system which feeds the gas after the first and second vaporization into the condensing region 2 and condenses it. Secondary vaporization and condensation are repeatedly performed after primary vaporization and condensation while air flow is circulated between both the regions.

### (Lower Chamber 20)

Further, in embodiment 3, the lower side of the vaporizing region 1 is partitioned with the inner bottom B3, to provide a lower chamber 20 defined by the inner bottom 3 in the lower side of the apparatus main body B.

The lower chamber 20 is formed at the lower side of the apparatus main body B with the inner bottom B3 as the boundary wall which closes the lower side of the vaporizing region 1. A communication duct with the vaporizing region 1 of the apparatus main body B penetrates through the inner bottom B3, and the communication duct is provided with the fan F which blows air flow into the vaporizing region 1 from the lower chamber 20 as the air flow circulating means. The air flow which passes through the inside of the condensing region pipe 15 is discharged into the lower chamber 20 from the lower communication part 8, and is circulated upward to the vaporizing region 1 of the apparatus main body B from the communication duct by the fan F. By being introduced again into the condensing region 2 from the upper communication part 7 at the upper portion of the vaporizing region 1, the air flow circulates in the vertical direction in the apparatus, and circulates in each of the regions via the lower chamber 20.

The part in the vicinity of the lower end of the condensing region pipe 15 penetrates through the inner bottom B3, and the lower end is opened in the lower chamber 20 as the lower communication part 8. The part in the vicinity of the lower end does not have the branch pipe 150 as in embodiment 1, and the air flow and the condensed water 9 after being condensed both flow into the lower chamber 20 from the lower communication part 8 at the lower end of the pipe.

(Vaporizing Means with Two Systems)

The vaporizing means with two systems includes primary vaporizing means which heats and feeds under pressure the raw seawater 4 from the external raw seawater tank 40 and primarily vaporizes the raw seawater 4 in the vaporizing region 1, and secondary vaporizing means which again heats and feeds under pressure the concentrated seawater 6 which is not primarily vaporized and is stored in the lower side of the vaporizing region 1 from the storage reservoir for the concentrated seawater 6, and secondarily vaporizes the concentrated seawater 6 in the same vaporizing region 1.

The primary vaporizing means includes a lower preheating pipe which communicates with the water supply pipe which penetrates through the inside of the lower chamber 20 via a first pressure pump P1 from the inside of the raw seawater tank 40, and meanders in the lower chamber 20, a first seawater preheating pipe 31 which communicates with the lower preheating pipe at its tip end, and runs from the open end of the lower communication part 8 to the open end of the upper communication part 7 through the inside of the condensing region pipe 15, and a first seawater spraying device S1 which communicates with the first seawater preheating pipe 31 at its tip and is provided at the upper portion in the apparatus main body B.

The secondary vaporizing means includes a second seawater preheating pipe 32 which communicates with the water supply pipe which penetrates through the inside of the condensing region pipe 15 via a second pressure pump P2 from the storage reservoir of the concentrated seawater 6 stored in the inner bottom B3 of the apparatus main body B, and is laid from the penetrated portion to the open end of the upper communication part 7 through the inside of the condensing region pipe 15, and a second seawater spraying device S2 which communicates with the second seawater preheating pipe 32 and is provided at the upper portion in the apparatus main body B.

Along the inside of the condensing region pipe 15 of embodiment 3, the two seawater preheating pipes 3 extend; specifically the first seawater preheating pipe 31 from the lower end inside the lower chamber 20 to the upper end in the upper portion of the apparatus main body B, and the second seawater preheating pipe 32 from the lower penetrated portion inside the apparatus main body B to the upper end in the upper portion of the apparatus main body B. The two seawater preheating pipes 3 are both provided inside the condensing region pipe 15, projecting from the upper communication part 7 at the upper end of the condensing region 2, and communicate with the first seawater spraying device S1 and the second seawater spraying device S2, respectively.

### (Inner Bottom B3)

On the inner bottom B3 is provided the concentrated seawater 6 reservoir to store the concentrated seawater 6 not vaporized by spraying as the condensed seawater. The inner bottom B3 is formed by a bowl shaped body or a downward pyramid as shown in FIG. 6, and is provided with a salt recovering pipe which passes through the lower chamber 20 from the lowermost projected portion of the inner bottom B3 to communicate with a salt recovering device 18 outside the apparatus. Outside the salt recovering pipe, a plurality of disk-shaped heat exchanging fins 19 are fixed to project into the lower chamber 20. By the heat exchanging fins 19, heat is prevented from releasing to the external salt recovering device 18 side at the time of recovery of the salt 5.

The other constitution and process of desalination not specially described are the same as those in embodiment 1.

In addition, the present invention is not limited to the above mentioned embodiments or the above mentioned other constitutional examples, but various modifications such as replacement and combination of each of the elements of each of the embodiments, extraction of the elements and change of modes can be made within the range without departing from the spirit of the present invention.

### INDUSTRIAL APPLICABILITY

In addition, the present invention has the possibility of concentrating various rare elements dissolved in seawater and crystallizing them. While global water shortage is foreseen to be more serious in the future, no inexpensive seawater desalination means is available yet, and large amount of energy is consumed for concentrating salt from seawater. The air flow circulation seawater desalination means allows desalination of a large amount of seawater at extremely low cost for the reason of a very small amount of energy consumption as compared with the conventional seawater desalination method or the like, and is considered to contribute to construction of a low carbon economy society in harmony with the natural environment of the earth.

### BRIEF DESCRIPTION OF THE DRAWINGS

FIG. 1 is an explanatory view showing a basic constitution of a desalination apparatus of seawater of the present invention.

FIG. 2 is an explanatory view showing a system of a greenhouse type air flow circulation seawater desalination apparatus of embodiment 1 of the present invention.

FIG. 3 is an explanatory view in a side view showing a system of an air flow seawater desalination apparatus of embodiment 2 of the present invention.

FIG. 4 is an explanatory view taken along a I-I section in a plane view of FIG. 3 showing a constitution of an upper part in the air flow circulation seawater desalination apparatus of embodiment 2.

FIG. 5 is an explanatory view taken along a II-II section in a plane view of FIG. 3 showing a constitution of a lower part in the air flow circulation seawater desalination apparatus of embodiment 2.

FIG. 6 is an explanatory view showing a system of an air flow circulation seawater desalination apparatus of embodiment 3 of the present invention.

FIG. 7 is a graph showing relationship of saturated steam pressure of water.

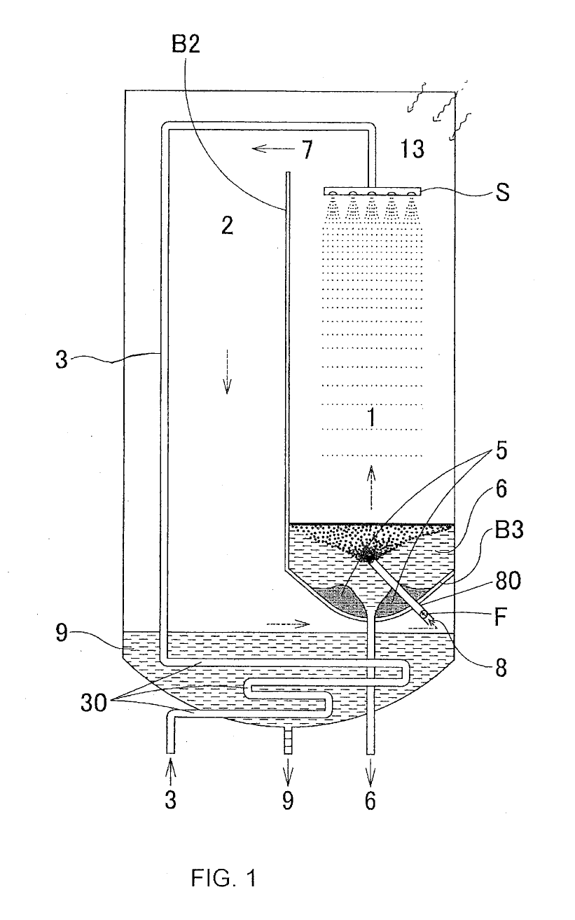

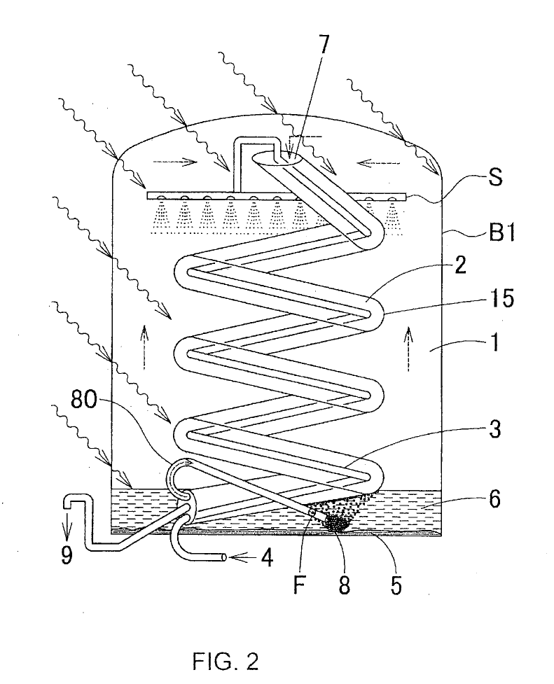

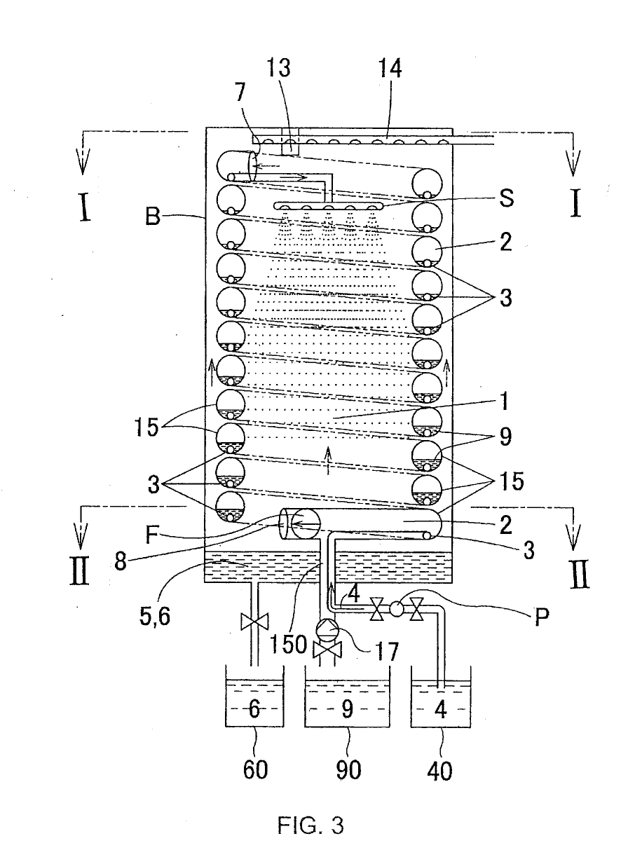

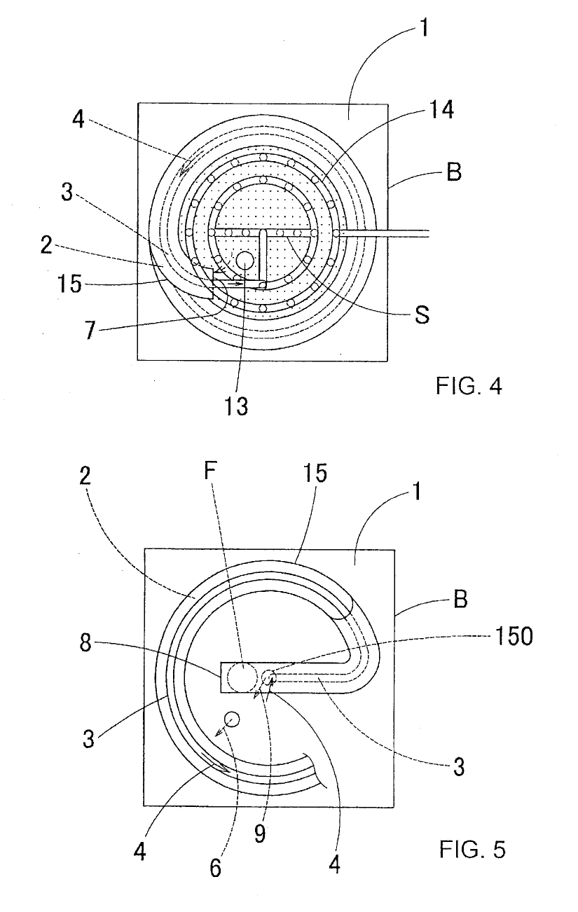

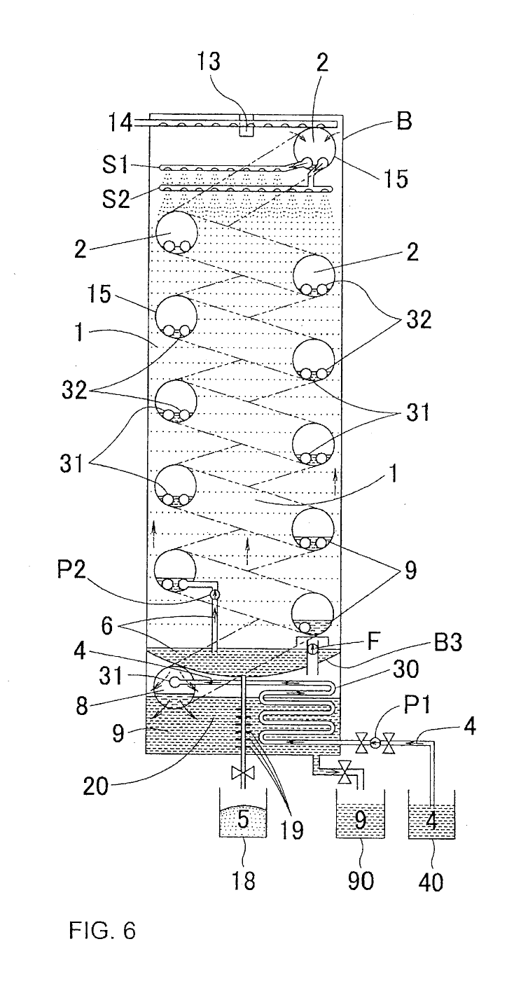

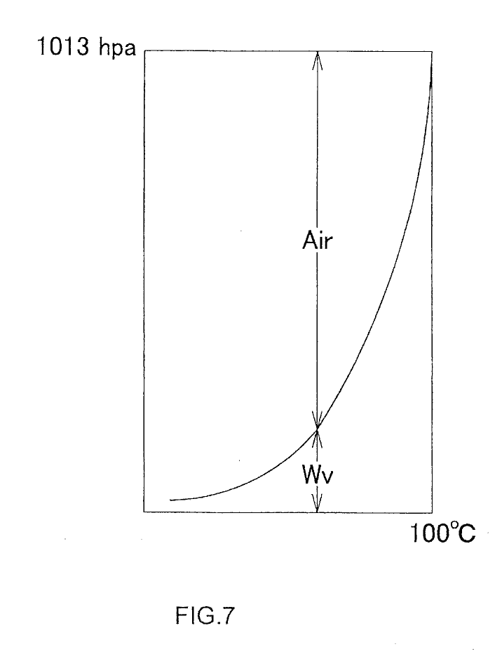

### DESCRIPTION OF THE REFERENCE NUMBERS

1 vaporizing region
2 condensing region
3 seawater preheating pipe
30 lower seawater preheating pipe
31 first seawater preheating pipe
32 second seawater preheating pipe
4 raw seawater
40 raw seawater tank
5 salt
6 concentrated seawater
60 concentrated seawater tank
7 upper communication part
71 first upper communication part
72 second upper communication part
8 lower communication part
81 first lower communication part
82 second lower communication part
9 condensed water
90 condensed water tank
13 heat supply section
14 injection cleaning device
15 condensing region pipe
17 check valve
18 salt recovering device
19 heat exchanging fin
20 lower chamber
B apparatus main body
B1 outer wall
B2 inner wall
B3 inner bottom
F fan
F1 first fan
F2 second fan
P pressure pump
P1 first pressure pump
P2 second pressure pump
S seawater spraying device
S1 first seawater spraying device
S2 second seawater spraying device

1. An air flow circulation seawater desalination apparatus comprising:
a condensing region pipe having a pipe body spirally and vertically extending inside an apparatus main body, and opened into the apparatus main body at an upper end and a lower end, respectively, and constituting a boundary wall between a vaporizing region outside the pipe, and condensing region inside the pipe with communication with the vaporizing region at the upper end and lower end;
a heat supply section in an upper place of the vaporizing region that stores heat to keep an upper side in the apparatus main body at a high temperature;
air flow circulating means in a lower side of the apparatus main body that circulates air flow from the condensing region to the vaporizing region;
a seawater preheating pipe which penetrates through a lower side of the apparatus from an outside of the apparatus, passes inside the condensing region pipe, and undergoes heat exchange while carrying raw seawater to an upper portion of the vaporizing region to preheat the raw seawater;
a seawater spraying device for producing high-temperature steam in the upper place inside the apparatus by spraying the raw seawater from an upper place of the vaporizing region to evaporate the raw seawater;
in the desalination apparatus of seawater, air flow is circulated in both the vaporizing region and the condensing region which are adjacent via the condensing region pipe as a heat exchanger to perform vaporization and steam condensation;
wherein latent heat released when the high-temperature steam with a large buoyant force produced in the upper place of the vaporizing region is sucked from the upper end of the condensing region pipe and returned to water at a lower temperature in a lower side in the condensing region pipe, effectively evaporates seawater in the adjacent vaporizing region, and thereby, steam condensation and seawater evaporation are simultaneously proceed inextricably associated with each other.

2. The air flow circulation seawater desalination apparatus according to claim 1, wherein the seawater preheating pipe passes in the condensing region in the apparatus, and by heat exchange between an inside and an outside of the seawater preheating pipe, provides a heat recovery step of causing the raw seawater to recover heat of condensed water in the condensing region which is extracted outside the apparatus, a condensation promoting step of causing the raw seawater to promote steam condensation of air flow in the lower portion of the condensing region, and a temperature raising step of raising temperature of the raw seawater by condensing action of steam which is air flow in the condensing region.

3. The air flow circulation seawater desalination apparatus according to claim 1,
wherein a lower place in the apparatus has a temperature which is different from temperature of the upper place of the apparatus by storing heat in the upper place in the apparatus and increasing temperature of the upper place in the apparatus with high-temperature steam by the heat supply section,
latent heat generated when high-temperature steam obtained by generating by spraying the raw seawater to the upper place of the vaporizing region is sucked to the lower side of the condensing region pipe with a low temperature by the air flow circulating means and returned to water, is directly used for vaporization of seawater of the adjacent vaporizing region, and
continuous heat exchange is kept by causing air flow to circulate in both the condensing region and the vaporizing region in which vaporization and condensation of steam are simultaneously advanced inextricably associated with each other.

4. The air flow circulation seawater desalination apparatus according to claim 2,
wherein a lower place in the apparatus has a temperature which is different from temperature of the upper place of the apparatus by storing heat in the upper place in the apparatus and increasing temperature of the upper place in the apparatus with high-temperature steam by the heat supply section,
latent heat generated when high-temperature steam obtained by generating by spraying the raw seawater to the upper place of the vaporized region is sucked to the lower side of the condensing region pipe with a low temperature by the air flow circulating means and returned to water, is directly used for vaporization of seawater of the adjacent vaporizing region, and
continuous heat exchange is kept by causing air flow to circulate in both the condensing region and the vaporizing region in which vaporization and condensation of steam are simultaneously advanced inextricably associated with each other.
